(19) United States
(12) Patent Application Publication
(10) Pub. No.: US 2010/0006312 A1
(43) Pub. Date: Jan. 14, 2010

(54) LIGHTNING PROTECTION DEVICE FOR A WIND TURBINE BLADE: WET/DRY GLOW-BASED STREAMER INHIBITOR

(76) Inventors: Farouk A. M. Rizk, Saint-Lambert (CA); Amir Rizk, Saint-Lambert (CA)

Correspondence Address: GOUDREAU GAGE DUBUC, 2000 MCGILL COLLEGE, SUITE 2200, MONTREAL, QC, H3A 3H3, CA

(21) Appl. No.: 12/444,284

(22) PCT Filed: Oct. 4, 2007
(86) PCT No.: PCT/CA2007/001768

§ 371 Date: Apr. 3, 2009

Related U.S. Application Data
(60) Provisional application No. 60/849,007, filed on Oct. 4, 2006.

(51) Int. Cl. H02G 13/00

(52) U.S. Cl. 174/2

(57) ABSTRACT

A lightning protection device for reducing exposure of a wind turbine blade to conventional and upward lightning strikes, the device includes a support structure adapted to be grounded for mounting on the blade. The protection device also has a set of grounded space charge producing conductors attached to the support structure and arranged therewith to form a space charge producing element for producing space charge of opposite polarity to a cloud charge. Each space charge producing conductor has a diameter not exceeding 0.1 mm for reducing a corona inception voltage of the support structure upon which each space charge producing conductor is arranged, in both dry and wet conditions.

### FIELD OF THE INVENTION

The present invention generally relates to lightning protection devices and more particularly concerns a lightning protection device for a wind turbine blade.

### BACKGROUND OF THE INVENTION

It is well known that most lightning discharges are associated with predominantly negatively charged clouds. Two main categories of lightning strikes are encountered: Upward flashes from very tall structures and the more prevalent strikes associated with negative descending stepped leaders, as explained in “Modeling of Lightning Incidence to Tall Structures Part I: Theory”, Farouk A. M. Rizk, IEEE Trans. on Power Delivery, Vol. 9, No. 1 January 1994, pp. 162-171, and also in “Modeling of Lightning Incidence to Tall Structures Part II: Application”, Farouk A. M. Rizk, IEEE Trans. on Power Delivery, Vol. 9, No. 1 January 1994, pp. 172-193. The negative descending leader is surrounded with a negative space charge sheath which, as the negative leader approaches the ground, induces positive (image) charges on any grounded object in its sphere of influence. The higher the grounded structure and the nearer it is to the path of the descending negative leader, the more significant the induced charge on the grounded structure.

It is known that a lightning stroke current is a statistical variable that varies in a wide range from a few kA to a few hundred kA with a median of 25-35 kA. The attractive radius of a structure i.e. the maximum radial distance around the structure in which a descending leader would be captured by the structure increases with both the stroke current, which is associated with the negative space charge jacket and the structure height.

In recent years, based on progress in research on the physics of breakdown of long air gaps, our understanding of the mechanisms by which different ground structures are hit by lightning have been substantially improved. In particular the role played by the grounded object in the strike mechanism has been clarified. As detailed in “Modeling of Transmission Line Exposure to Direct Lightning Strokes”, Farouk A. M. Rizk, IEEE Trans. on Power Delivery, Vol. 5, October 1990, pp 1983-1997, modeling has shown that the attractive radius comprises two parts: a major part (two thirds or more) spanned by the positive leader emanating from the structure and the lesser part constituting the final jump between the negative and positive leader tips.

Electrostatic field analysis shows that the electric field enhancement at the surface of and in the vicinity of any grounded structure is predominately caused by the positive (image) charge that has been induced onto the grounded structure by the cloud charge and/or the descending negative leader and that this far exceeds the background field due to the cloud charge and/or the descending leader itself. Depending on the structural characteristics of the grounded object an inception field caused by the induced charge is reached when ionization of the surrounding air takes place causing corona discharge and positive streamer formation. Depending on the geometry of the grounded structure and the amount of induced positive charge the length of the positive streamer can grow into the meter range.

As detailed in “A Model for Switching Impulse Leader Inception and Breakdown of Long Air-Gaps”, Farouk A. M. Rizk, IEEE Trans. on Power Delivery, Vol. 4, No. 1, January 1989, pp. 596-606, and also in “Switching Impulse Strength of Air Insulation: Leader Inception Criterion”, Farouk A. M Rizk, IEEE Trans. On power Delivery, Vol. 4. No. 4, October 1989, pp. 2187-2195, if the positive streamer reaches a critical size, a highly conducting stem is formed at the streamer junction to the structure and a positive leader is thereby formed. Contrary to the positive streamer which has a mean gradient of approximately 400-500 kV/m, the leader gradient is a function of both the leader current and the time duration of its existence. For a current of 1 A the leader gradient could be 30-50 kV/m i.e. approximately one tenth of the positive streamer gradient but for a leader current of the order of 100 A the leader gradient could go down to as low as 2-3 kV/m. This shows that contrary to the positive streamer, a positive leader is capable of traveling distances in the 100 m range without requiring unrealistically high electric potential.

It is important to note that not every positive leader emanating from a grounded structure will complete the trajectory to encounter the descending negative leader in a final jump. As the positive leader travels farther and farther from the structure its motion will be governed more and more by such parameters as space potential and the electric field ahead of the leader tip, which are determined more and more by the descending leader charge and less and less by the grounded structure. When conditions are not appropriate for continued propagation, the positive leader stops and the concerned grounded structure which started the positive streamer/positive leader process is not struck.

Objects that are struck by downward negative lightning are those which, due to their induced positive charge, “succeed” in creating long positive streamers resulting in the formation of a positive leader which progresses in a zone of increasing electric field in order to meet the approaching descending negative lightning leader in what is termed the final jump. The final jump takes place when the mean voltage gradient between the tip of the ascending positive leader and the tip of the descending negative lightning leader reaches 500-600 kV/m.

As seen from the negative descending lightning leader, all grounded objects with their respective induced positive charges are in a competition which determines: which among them will produce significant positive streamer activity and which among them will “succeed” in producing a positive leader that will complete the trajectory to the final jump. If no elevated structure “succeeds” in completing the trajectory to the final jump, the negative descending leader will proceed to ground by default. Therefore if the intent is to reduce the risk of such a lightning strike it will be of great advantage for any structure to remain electrically silent, i.e. to be inactive or inhibited in the game of producing long positive streamers.

The second type of lightning flash referred to above is the upward flash which takes place in the form of an upward positive streamer/leader process without the presence of a negative descending leader. The probability of this type of lightning strokes becomes significant in structures with heights in excess of 100 m on flat ground. They can also take place on much shorter structures on mountain tops. Here the field enhancement at and in the proximity of the structure is caused by the induced positive charge on the structure directly caused by the negative charge of the cloud alone since no descending leader is present.

For upward lightning the ambient (ground) field needed for positive leader inception depends mostly on the structure height. For tall structures the critical ambient field is in fact related to the structure height by the simple relationship E_{g}=1600/h where E_{g} is given in kV/m and the structure height h is given in meters. As discussed in “Modeling of Lightning Incidence to Tall Structures Part I: Theory” and “Modeling of Lightning Incidence to Tall Structures Part II: Application” previously mentioned, even for the tallest structures the critical ambient field should exceed 3 kV/m. Therefore and once again if the intent is to reduce the risk of an upward lightning strike, it will be of great advantage for any structure to remain electrically silent, i.e. to be inactive or inhibited or to require higher fields than normal to participate in the game of producing long positive streamers.

### BACKGROUND OF THE PRIOR ART

Lightning protection practices can be divided into two broad categories. The first being variations on the Franklin Rod or overhead ground wires whose purpose is to give a preferential path for the current of a lightning stroke and thus prevent potential damage. These systems do not claim to affect the probability of occurrence of a lightning strike.

The other broad category of lightning protection practices can be called “the dissipation systems”, as described in U.S. Pat. No. 5,043,527 (Carpenter), U.S. Pat. No. 4,910,636 (Sadler et al.), and U.S. Pat. No. 4,605,814 (Gillem). These systems use points or end-tips of wires or rods to produce space charge. There are several contradicting statements, with little or no scientific basis, on how these devices are supposed to work. Some dissipation system proponents claim that the production of space charge can neutralize the negative charge of the cloud and thereby eliminate lightning, which is an unrealistic task. Other dissipation systems proponents claim that the dissipation of ions from the protected structure will reduce the accumulated charge by blowing it downwind and reduce or minimize the potential difference between the charged cloud and the protected structure.

These claims are of course physically invalid since the induced (image) charges on a grounded structure are charges which remain in place so long as the inducing charges of the cloud or descending leader remain and cannot be dissipated into the surrounding air. Furthermore it is a well established scientific fact that metals do not emit positive ions. On the contrary positive space charge is formed by ionization processes that result in electrons being collected by the electrode (structure) and injected into the ground leaving the positive ion space charge behind in the surrounding air. Also changing the potential between the cloud and a grounded object necessarily means the unrealistic task of changing the potential of the cloud since by definition the grounded structure, unless struck by lightning, is and will always remain at ground potential.

Another proposed lightning protection device is the wet/dry glow based streamer inhibitor of the same Applicants of the present invention described in International application published under No. WO2007/059600 on May 31, 2007. This wet/dry glow based streamer inhibitor uses coils of conductors whose diameters do not exceed 0.1 mm for producing space charge, streamer free, to reduce the risk of a lightning strike to an object to be protected. These coils are to be wound around a support structure that is adapted to be grounded. However, it has been discovered that some support structures, like a wind turbine blade, are not easily fitted with coils and in fact the presence of a coil that surrounds the wind turbine blade could be detrimental to its aerodynamic functionality.

Therefore, it would be desirable to provide a less obtrusive, less complicated method of providing a wind turbine blade with the space charge producing elements.

It would also be desirable to provide an improved lightning protection device that would be particularly adapted for use with a wind turbine blade without harming its aerodynamics, and which would be easy to install.

### STATEMENT OF THE OBJECT OF THE INVENTION

An object of the present invention is to control the inception of positive streamer/leader from a wind turbine blade under different atmospheric conditions.

The first possibility for controlling positive leader inception from a grounded structure terminal is to modify the terminal geometry. It must be noted however that in the case of a wind turbine blade, any attempts to modify the geometry of the structure must not interfere with its aerodynamic functionality, making therefore this approach impractical.

The second technique for controlling discharge activity from a structure terminal is by space charge shielding. For the device producing positive space charge to be successful in protecting a structure terminal, several prerequisites are in order:
1. The space charge producing device must not produce corona in the positive streamer mode. Such positive streamer production will defeat the purpose of positive space charge generation and may in fact enhance the probability of the device being struck by lightning as per the mechanism described above. This requirement alone could exclude many devices based upon the point discharge since points or point arrays are generally known to be prone to positive streamer production.
2. The device must be able to be streamer free, not only under dry conditions but also under wet conditions. This requirement is obvious since lightning is usually associated with rain. A device that functions as required only in dry conditions will not be adequate.
3. The device must be able to produce sufficiently high rates of space charge, streamer free, to achieve its intended goal even under windy conditions. Furthermore, packing a large number of discharge points in close proximity will not solve this problem since close points will interact and limit their ability to produce space charge.
4. The device must afford some means of control of the production of space charge so as to be applicable in a variety of situations and conditions.
5. In order to inhibit the development of positive streamers from a grounded structure when desired, the device must produce a sufficiently high rate of space charge, streamer free, in the relatively short time available when the ambient field increases ahead of the lightning stroke and in the few tens of milliseconds as the negative leader moves towards the earth producing variations of the space potential in the range exceeding 1 kV/μs.

Another object of the present invention is to provide a wind turbine blade with a streamer free space charge producing element since wind turbine blades are not easily fitted with coils.

In view of the above, it is a further object of the present invention to provide a wet/dry glow-based streamer inhibitor that meets all the required criteria listed for the space charge shielding technique for controlling discharge activity from a grounded structure terminal and for providing a wind turbine blade with a streamer free space charge producing element.

### SUMMARY OF THE INVENTION

According to the present invention, there is provided a lightning protection device for reducing exposure of a wind turbine blade to be protected from conventional and upward lightning strikes, the device comprising:
a support structure adapted to be grounded for mounting on the blade, the support structure having a supporting portion attachable to the wind turbine blade and an opposite exposed portion; and
a set of grounded space charge producing conductors attached to the support structure and arranged therewith to form a space charge producing element for producing space charge of opposite polarity to a cloud charge, each conductor having two opposed ends and a longitudinal portion there between and being mounted on the support structure so that at least a part of the longitudinal portion extends on the exposed portion of the support structure, each space charge producing conductor having a diameter not exceeding 0.1 mm for reducing a corona inception voltage of the support structure upon which each space charge producing conductor is arranged, in both dry and wet conditions.

Advantageously, thanks to the space charge producing element, the protection device inhibits a formation of streamers from the wind turbine blade.

Preferably, the space charge producing conductors are selected from the group including a conducting wire, a bundle of conducting wires, a conducting fiber, a conducting filament, a bundle of conducting filaments, a yarn made of conducting wires, a yarn made of a bundle of conducting wires, a yarn made of conducting fibers, a yarn made of conducting filaments, a yarn made of a bundle of conducting filaments, a knitted fabric made of conducting wires, a knitted fabric made of a bundle of conducting wires, a knitted fabric made of conducting fibers, a knitted fabric made of conducting filaments, a knitted fabric made of a bundle of conducting filaments, a woven fabric made of conducting wires, a woven fabric made of a bundle of conducting wires, a woven fabric made of conducting fibers, a woven fabric made of conducting filaments, and a woven fabric made of a bundle of conducting filaments, and wherein each of said wires, fibers and filaments has a diameter not exceeding 0.1 mm.

Preferably, the space charge producing conductors are attached to the support structure to form a single layer of conductors or multiple layers of conductors.

Preferably, the space charge producing conductors are attached to the support structure in a longitudinal direction and/or a transverse direction.

Preferably the support structure has a predetermined radius of curvature which renders the electric field on the space charge producing conductors above the corona inception level for practical values of the space potential.

In use, when the device is properly shaped and dimensioned and exposed to the electric fields that precede a lightning strike it goes into glow mode corona and produces a high and predictable rate of positive space charge in both wet and dry conditions. This rate of positive space charge production is sufficient, even in windy conditions, to induce a negative charge on structures or conductors within a defined area and inhibit the development of positive streamers thereby reducing the risk of both conventional and upward lightning strikes.

Because of this unique property of producing high rates of positive space charge without streamers, in both dry and wet conditions, negative charges are induced on the metallic structural parts of the wind turbine and when wet, and therefore conducting, negative charges are also induced on the wind turbine blade surface even under windy conditions. Such induced negative charges counteract the positive charge induced on the wind turbine blade by the negative charge of the cloud or the descending negative leader. This has the effect of inhibiting positive streamer formation from the wind turbine blade or in particular inhibiting the streamers from reaching the critical size needed for transformation into a leader discharge and therefore reduce the wind turbine blade's participation in the lightning attachment process and thus reduce its vulnerability to a lightning strike.

According to another aspect, the present invention also provides a method for reducing exposure of a wind turbine blade from conventional and upward lightning strikes, the method comprising steps of:
providing a support structure adapted to be grounded for mounting on the blade, the support structure having a supporting portion attachable to the wind turbine blade and an opposite exposed portion;
forming with the support structure a space charge producing element comprising a plurality of grounded space charge producing conductors arranged together for producing space charge of opposite polarity to a cloud charge, each conductor having two opposed ends and a longitudinal portion there between and being mounted on the support structure so that at least a part of the longitudinal portion extends on the exposed portion of the support structure, each space charge producing conductor having a diameter not exceeding 0.1 mm for reducing a corona inception voltage of the support structure, in both dry and wet conditions; and
attaching the support structure on the turbine blade.

The invention as well as its numerous advantages will be better understood by reading of the following non-restrictive description of preferred embodiments made in reference to the appended drawings.

### BRIEF DESCRIPTION OF THE DRAWINGS

FIG. 1 is a top view of a wind turbine blade provided with a lightning protection device, according to a preferred embodiment of the present invention.

FIG. 2 is a cross sectional view of the wind turbine blade of FIG. 1.

FIG. 3A is a cross sectional view of a support structure, according to a preferred embodiment of the present invention.

FIG. 3B is a plan view of the support structure of FIG. 3A.

While the invention will be described in conjunction with example embodiments, it will be understood that it is not intended to limit the scope of the invention to such embodiments. On the contrary, it is intended to cover all alternatives, modifications and equivalents as may be included as defined by the appended claims.

### DESCRIPTION OF PREFERRED EMBODIMENTS

In the following description, similar features in the drawings have been given similar reference numerals and in order to lighten the figures, some elements are not referred to in some figures if they were already identified in a precedent figure.

As explained above, in International application published under No. WO2007/059600 of the same Applicants, a number of examples for the support structure of the protection device has been given. As explained, the use of the wind turbine blade as the primary support structure upon which the thin conductors would be wrapped can work. However, it has been thought that an easier and more practical approach would be to use an intermediate conducting support structure for the thin space charge producing conductors in place of the wind turbine blade as primary support structure. This new support structure is possibly of a cylindrical or semi cylindrical shape even if other shape could be envisaged. This support structure which would be grounded would be wrapped in the thin conductors to form a space charge producing element which would then be integrated into the wind turbine blade. This device comprising a support structure and space charge producing conductors to be mounted onto a wind turbine blade may also be applicable to other structures which are sensitive to lightning such as a radome.

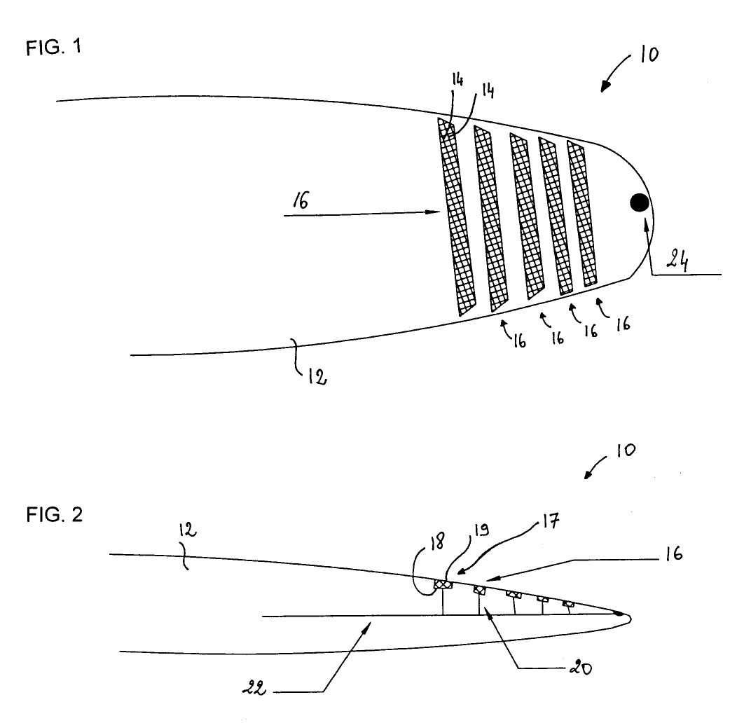

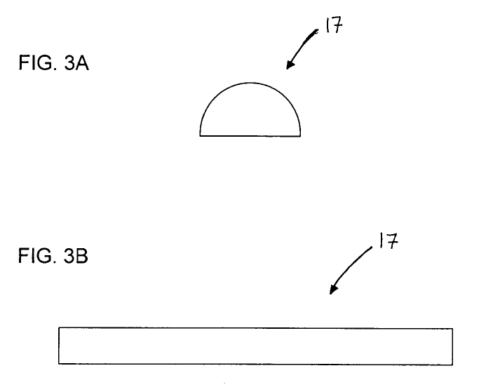

Referring to FIGS. 1 and 2, there is shown a lightning protection device 10 used to protect a wind turbine blade 12, according to a preferred embodiment of the present invention. As previously mentioned, the lightning protection device 10 of the present invention is particularly intended to reduce exposure of a wind turbine blade from conventional and upward lightning strikes. The protection device 10 is provided with a support structure 17 adapted to be grounded for mounting on the blade 12. FIGS. 3A and 3B show a preferred embodiment of a semi-cylindrically shaped support structure 17 but it should be understood that other convenient shape for the support structure 17 could be used. The support structure has a supporting portion 18 attachable to the wind turbine blade 12 and an opposite exposed portion 19. As illustrated, the protection device 10 is also provided with a set of grounded space charge producing conductors 14 attachable to the support structure 17 and arranged therewith to form a space charge producing element 16 for producing space charge of opposite polarity to a cloud charge, each space charge producing conductor 14 having a diameter not exceeding 0.1 mm for reducing a corona inception voltage of the support structure 17 upon which each space charge producing conductor 14 is arranged, in both dry and wet conditions.

Advantageously, each conductor 14 has two opposed ends and a longitudinal portion there between. Each conductor 14 is mounted on the support structure 17 so that at least a part of the longitudinal portion extends on the exposed portion 19 of the support structure 17. Indeed, since part of the conducting support structure 17 will be fixed to the wind turbine blade 12 and not exposed to the atmosphere, there may be some advantage in only covering that portion which is exposed to the atmosphere with the space charge producing thin conductors 14. It should be noted however that it is the longitudinal section in between the two end points of the thin conductors 14 that is to be exposed to the atmosphere.

As previously mentioned, the space charge producing conductors 14 can be any kind of conducting wires, but their diameter must not exceed 0.1 mm.

In a preferred embodiment, the support structure has a predetermined radius of curvature to provide an electric field on the space charge producing conductors 14 above the corona inception voltage for practical values of the space potential.

Still referring to FIGS. 1 and 2, it can also be envisaged to mount several space charge producing elements 16 on the same wind turbine blade 12. In this case, the lightning protection device 10 is further provided with several additional sets of grounded space charge producing conductors 14 arranged on corresponding additional support structures to form additional space charge producing elements 16 attachable to the wind turbine blade 12. In the illustrated case, five elements 16 are provided but it should be understood that other arrangement could be envisioned according to a specific application.

As better shown in FIG. 2, the space charge producing elements 16 are advantageously connected to ground via ground wires 20, which may be in turn connected to the conventional ground wire 22 of a conventional lightning protection metal tip 24. Of course, other arrangements could be considered as long as the space charge producing elements 16 are conveniently grounded.

According to another aspect, the present invention also provides a method for reducing exposure of a wind turbine blade 12 from conventional and upward lightning strikes, the method comprising steps of:
providing a support structure adapted to be grounded for mounting on the blade 12, the support structure having a supporting portion 18 attachable to the wind turbine blade 12 and an opposite exposed portion 19;
forming with the support structure a space charge producing element 16 comprising a plurality of grounded space charge producing conductors 14 arranged together for producing space charge of opposite polarity to a cloud charge, each conductor 14 having two opposed ends and a longitudinal portion there between and being mounted on the support structure so that at least a part of the longitudinal portion extends on the exposed portion 19 of the support structure, each space charge producing conductor 14 having a diameter not exceeding 0.1 mm for reducing a corona inception voltage of the support structure, in both dry and wet conditions; and
attaching the support structure on the turbine blade 12.

This method is particularly advantageous since most wind turbine blades could be modified in a simple manner in order to reduce their exposure to lightning strikes.

### EXPERIMENTAL TESTS

Between Jan. 23 and 31 of 2006 the authors of the present application commissioned and witnessed two series of experiments at Hydro Quebec's High Voltage Laboratory. The objective of the tests was to determine the effect that thin wires would have on:
The corona inception voltage of an electrode;
The production of impulsive currents (streamers) versus DC currents (glow-mode corona);
The breakdown voltage of a 1.5 meter double toroid-plane air gap where the test electrodes served as the anode.

A number of identical stainless steel test electrodes were constructed, each electrode consists of two toroids whose major diameters are one meter and whose minor diameters are 2.54 cm (one inch) and the toroids are mounted 30 cm (12 inches) apart, symmetrically on a stainless steel frame. One double toroid test electrode was left bare and served as the “control” while the other test electrodes were wound with varying quantities of:
A 50 micron (diameter) stainless steel wire;
A bundle of 275 filaments of 12 micron (diameter) stainless steel fibre;
A woven fabric made of a bundle of filaments of 12 micron (diameter) stainless steel fiber.

In the first series of experiments, the test electrodes were mounted 3.5 m above ground on a vertical aluminium pole of diameter 10 cm (4 inches). A conducting plate of approximately 6 m diameter was suspended above the test electrodes at a height of 5 meters above ground or 1.5 meters above the test electrode. Each electrode was tested separately under direct voltage (DC) in both wet and dry conditions. The voltage of the conducting plate was raised to negative 600 kV in approximately 45 seconds and we took note of the corona inception voltage (through measurements of current flow as well as the monitoring of visible discharges and audible noise), the voltage was held at 600 kV for one minute and then raised until breakdown. It was noted that for the dry bare “control” electrode the corona inception voltage was approximately 400 kV and the breakdown voltage of the 1.5 meter gap was approximately 650 kV. Furthermore it was producing significant streamer activity from 400 kV up until breakdown. When the same electrode was wet the corona inception voltage was approximately 250 kV with little change in the breakdown voltage and significant streamer activity.

However, when the correct quantities of thin wires or thin fibers or a woven fabric made of such fibers was wound around the test electrodes and they were exposed to the same conditions, there were significant differences observed. The corona inception voltage, in both wet and dry conditions, was reduced to as low as 150 kV. The breakdown voltage of the gap was increased by approximately 150 kV and the electrode produced a DC current as high as 1.7 mA or it produced space charge at a rate of approximately 1.7 mC/s. Furthermore, the electrodes produced no streamers at all right up until breakdown in both wet and dry conditions.

In the second series of tests, the test electrodes were connected directly to a positive DC source and suspended upside down 3.5 meters above a large steel plate grounded through a current measuring shunt. The voltage was raised in steps up to 800 kV and measurements and observations were made during each plateau. It was observed that the bare test electrode had significant steamer activity both wet and dry but that once again the presence of the right configuration of thin wires or thin fibers eliminated any streamer activity and produced significant amounts of space charge. The second test series was not designed to reach breakdown of the gap.

Although preferred embodiments of the present invention have been described in details herein and illustrated in the accompanying drawings, it is to be understood that the invention is not limited to these precise embodiments and that various changes and modifications may be effected therein without departing from the scope of the present invention.

1. A lightning protection device for reducing exposure of a wind turbine blade from conventional and upward lightning strikes, the device comprising:
a support structure adapted to be grounded for mounting on said blade, said support structure having a supporting portion attachable to the wind turbine blade and an opposite exposed portion; and
a set of grounded space charge producing conductors attached to the support structure and arranged therewith to form a space charge producing element for producing space charge of opposite polarity to a cloud charge, each conductor having two opposed ends and a longitudinal portion there between and being mounted on said support structure so that at least a part of said longitudinal portion extends on the exposed portion of the support structure, each space charge producing conductor having a diameter not exceeding 0.1 mm for reducing a corona inception voltage of the support structure upon which each space charge producing conductor is arranged, in both dry and wet conditions.

2. The lightning protection device according to claim 1, wherein the space charge producing conductors are selected from a group including a conducting wire, a bundle of conducting wires, a conducting fiber, a conducting filament, a bundle of conducting filaments, a yam made of conducting wires, a yarn made of a bundle of conducting wires, a yarn made of conducting fibers, a yarn made of conducting filaments, a yarn made of a bundle of conducting filaments, a knitted fabric made of conducting wires, a knitted fabric made of a bundle of conducting wires, a knitted fabric made of conducting fibers, a knitted fabric made of conducting filaments, a knitted fabric made of a bundle of conducting filaments, a woven fabric made of conducting wires, a woven fabric made of a bundle of conducting wires, a woven fabric made of conducting fibers, a woven fabric made of conducting filaments and a woven fabric made of a bundle of conducting filaments, and wherein each of said wires, fibers and filaments has a diameter not exceeding 0.1 mm.

3. The lightning protection device according to claim 1, wherein said support structure has a predetermined radius of curvature to provide an electric field on the space charge producing conductors greater than the corona inception voltage.

4. The lightning protection device according to claim 1, further comprising at least one additional set of grounded space charge producing conductors arranged on an additional support structure to form an additional space charge producing element attachable to the wind turbine blade.

5. A method for reducing exposure of a wind turbine blade from conventional and upward lightning strikes, the method comprising steps of:
providing a support structure adapted to be grounded for mounting on said blade, said support structure having a supporting portion attachable to the wind turbine blade and an opposite exposed portion;
forming with said support structure a space charge producing element comprising a plurality of grounded space charge producing conductors arranged together for producing space charge of opposite polarity to a cloud charge, each conductor having two opposed ends and a longitudinal portion there between and being mounted on said support structure so that at least a part of said longitudinal portion extends on the exposed portion of the support structure, each space charge producing conductor having a diameter not exceeding 0.1 mm for reducing a corona inception voltage of the support structure, in both dry and wet conditions; and
attaching said support structure on said turbine blade.

6. A wind turbine blade having a lightning protection device as defined in claim 1 mounted thereon.
